(19) United States
(12) Patent Application Publication
(10) Pub. No.: US 2025/0363796 A1
(43) Pub. Date: Nov. 27, 2025

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Kei OCHIAI, Kanagawa (JP)

(21) Appl. No.: 19/212,250

(22) Filed: May 19, 2025

(30) Foreign Application Priority Data
May 23, 2024 (JP) 2024-084252

(51) Int. Cl. G06V 10/70; G06V 10/776; G06V 10/94

(52) U.S. Cl. CPC G06V 10/87; G06V 10/776; G06V 10/945

(57) ABSTRACT

An information processing apparatus comprises a selection unit configured to select a representative image, from among images captured by an imaging unit configured to perform processing in which a trained model is used on a captured image, in accordance with a user operation performed by a user in the capturing, and a change unit configured to evaluate a plurality of trained models by using the representative image selected by the selection unit and change a trained model to be used by the imaging unit based on a result of the evaluation.

### BACKGROUND

### Field of the Technology

The present disclosure relates to a technique for selecting a trained model.

### Description of the Related Art

In recent years, computer vision (CV) tasks in which machine learning methods are used are utilized in various scenes. As a conventional technique, there is a service in which a user, by creating a model that has been trained by machine learning (hereinafter referred to as “trained model”) in accordance with their purpose or selecting a trained model from a plurality of trained models published or distributed on the service, can use the trained model. For example, Japanese Patent Laid-Open No. 2022-105923 discloses a method of efficiently selecting a trained model by comparing a plurality of trained models by using results of object detection in the trained models.

However, since a user may not have a guideline for which images to use to be able to select a trained model suitable for their purpose, it is conceivable that comparison is performed with many images or images with which comparison is difficult, resulting in a problem that the selection of a trained model is not efficient.

### SUMMARY

The present disclosure provides a technique for efficiently selecting a trained model in accordance with the purpose.

According to the first aspect of the present disclosure, there is provided an information processing apparatus comprising: a selection unit configured to select a representative image, from among images captured by an imaging unit configured to perform processing in which a trained model is used on a captured image, in accordance with a user operation performed by a user in the capturing; and a change unit configured to evaluate a plurality of trained models by using the representative image selected by the selection unit and change a trained model to be used by the imaging unit based on a result of the evaluation.

According to the second aspect of the present disclosure, there is provided an information processing method performed by an information processing apparatus, the method comprising: selecting a representative image, from among images captured by an imaging unit configured to perform processing in which a trained model is used on a captured image, in accordance with a user operation performed by a user in the capturing; and evaluating a plurality of trained models by using the selected representative image and changing a trained model to be used by the imaging unit based on a result of the evaluation.

According to the third aspect of the present disclosure, there is provided a non-transitory computer-readable storage medium storing a computer program for causing a computer to function as: a selection unit configured to select a representative image, from among images captured by an imaging unit configured to perform processing in which a trained model is used on a captured image, in accordance with a user operation performed by a user in the capturing; and a change unit configured to evaluate a plurality of trained models by using the representative image selected by the selection unit and change a trained model to be used by the imaging unit based on a result of the evaluation.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of a hardware configuration of an information processing apparatus 1.

FIG. 2 is a block diagram illustrating an example of a functional configuration of a system in which the information processing apparatus 1 is applied.

FIG. 3 is a flowchart of operation of the system.

FIGS. 4A to 4D are diagrams illustrating changes in state of an imaging unit 210.

FIGS. 5A and 5B are diagrams illustrating changes in state of the imaging unit 210.

FIG. 6 is a flowchart of operation of the system.

FIG. 7 is a block diagram illustrating an example of a functional configuration of the system.

FIG. 8 is a diagram illustrating a change in state of the imaging unit 210.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

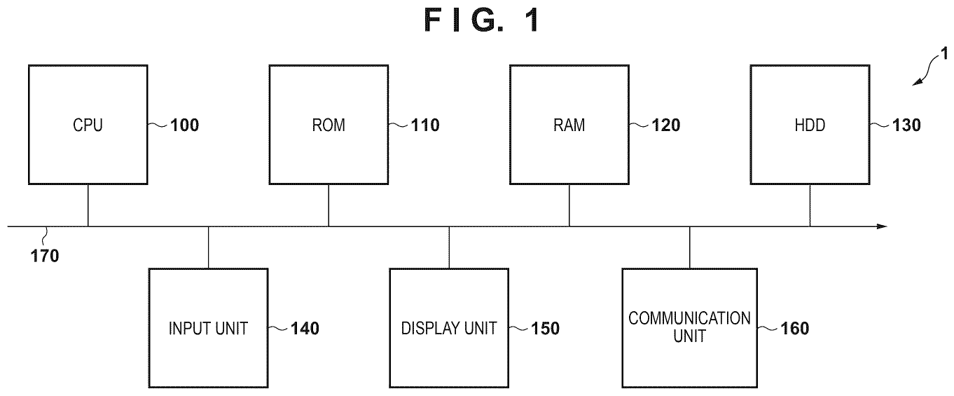

First, an example of a hardware configuration of an information processing apparatus 1 according to the present embodiment will be described with reference to a block diagram of FIG. 1. The information processing apparatus 1 according to the present embodiment is a computer apparatus, such as a PC, a tablet terminal device, or a smartphone.

A central processing unit (CPU) 100 executes various processes using computer programs and data stored in a RAM 120. The CPU 100 thus performs control of operation of the entire information processing apparatus 1 and executes or controls various processes described as processes to be performed by the information processing apparatus 1.

A read-only memory (ROM) 110 stores setting data of the information processing apparatus 1, computer programs and data related to startup of the information processing apparatus 1, computer programs and data related to a basic operation of the information processing apparatus 1, and the like.

The random access memory (RAM) 120 includes an area for storing computer programs and data loaded from the ROM 110 and a hard disk drive (HDD) 130. Further, the RAM 120 includes an area for storing computer programs and data received from an external apparatus via a communication unit 160. Further, the RAM 120 includes a work area that the CPU 100 uses when performing various processes. The RAM 120 can thus provide various areas as appropriate.

The HDD 130 stores an operating system (OS), computer programs and data for causing the CPU 100 to execute or control various processes described as processes to be performed by the information processing apparatus 1, and the like.

An external storage device may be used in addition to or in place of the HDD 130. The external storage device can be realized with, for example, a medium (recording medium) and an external storage drive for realizing access to the medium. As such a medium, for example, flexible disk (FD), CD-ROM, DVD, USB memory, MO, flash memory, and the like, are known. The external storage device may be a server device or the like connected with the information processing apparatus 1 via a network.

An input unit 140 is a user interface, such as a keyboard, a mouse, and a touch panel, and can input various kinds of instructions and information to the information processing apparatus 1 by being operated by a user.

A display unit 150 includes a screen, such as a liquid crystal screen or a touch panel, and can display a result of processing by the CPU 100 by using images, characters, and the like. The display unit 150 may be a projection device such as a projector for projecting images and characters.

The communication unit 160 performs data communication with an external apparatus via a network, such as a LAN or the Internet. For example, the information processing apparatus 1 may obtain, via the communication unit 160, various instructions and information inputted by the user operating an external apparatus.

The CPU 100, the ROM 110, the RAM 120, the HDD 130, the input unit 140, the display unit 150, and the communication unit 160 are all connected to a system bus 170. The hardware configuration applicable to the information processing apparatus 1 is not limited to the configuration illustrated in FIG. 1 and can be appropriately modified/changed.

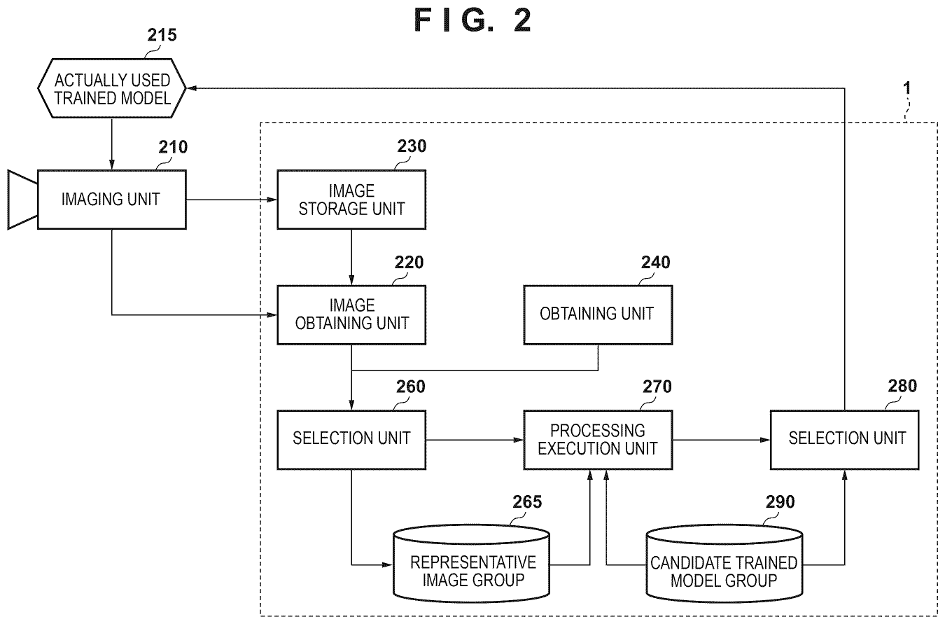

Next, FIG. 2 is a block diagram illustrating an example of a functional configuration of a system in which such an information processing apparatus 1 is applied. As illustrated in FIG. 2, the system includes an imaging unit 210, which includes an actually used trained model 215, and the information processing apparatus 1.

The actually used trained model 215 is a trained model that has been selected by the information processing apparatus 1 from a candidate trained model group 290 held in the information processing apparatus 1. The candidate trained model group 290 is a set of trained models that have been trained to detect a “subject to be a target of tracking auto focus (AF)” in an image and track the subject. Thus, the imaging unit 210 uses the actually used trained model 215 to detect a “subject to be a target of tracking AF” in an image captured by the imaging unit 210 and performs “tracking AF”, which is processing for automatically adjusting focus on the subject and tracking the subject based on the position at which the subject has been detected in the captured image.

The information processing apparatus 1 selects one or more captured images as selected images, from a group of images captured by the imaging unit 210, in accordance with a user operation related to tracking AF. Then, the information processing apparatus 1 evaluates the candidate trained model group 290 by using the selected images and changes the actually used trained model 215 based on a result of that evaluation.

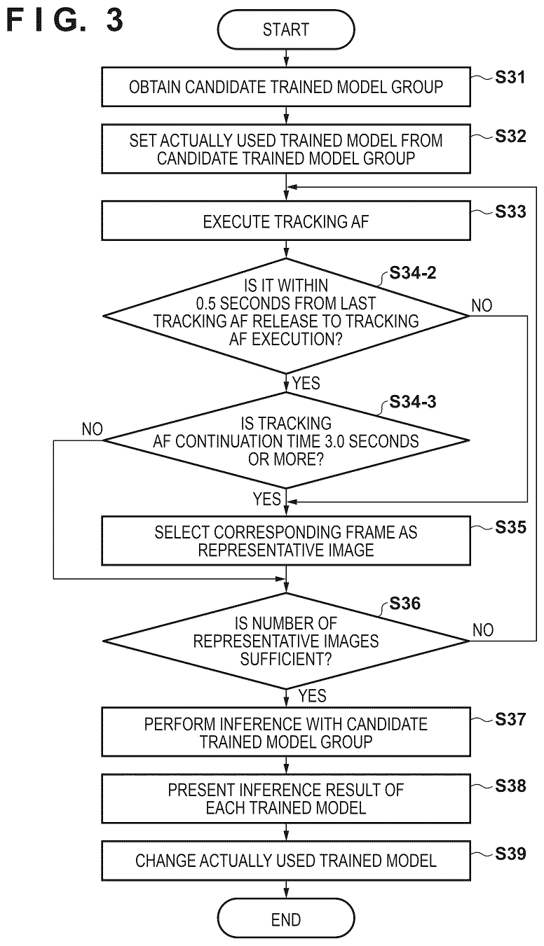

The operation of the system according to the present embodiment will be described in accordance with the flowchart of FIG. 3. In the following, a form in which, in the functional units of the information processing apparatus 1 illustrated in FIG. 2, an image storage unit 230 is implemented by the RAM 120 or the HDD 130 and respective functional units other than the image storage unit 230 is implemented by software (computer program) will be described. In the following, functional units (other than the image storage unit 230) of the information processing apparatus 1 illustrated in FIG. 2 will be described as performers of processing, but in practice, functions of the functional units are realized by the CPU 100 executing a computer program corresponding to the functional units. One or more of the functional units other than the image storage unit 230 may be implemented by hardware.

In step S31, a selection unit 280 obtains the candidate trained model group 290 and stores the obtained candidate trained model group 290 in the HDD 130 or the RAM 120. A method of obtaining the candidate trained model group 290 is not limited to a particular method. For example, the selection unit 280 may download the candidate trained model group 290 stored in an external apparatus (server device, external storage device, cloud, etc.) to the RAM 120 or the HDD 130 via the communication unit 160. Such a candidate trained model group 290 may be trained models created by the user themselves or may be generally distributed trained models.

In step S32, the selection unit 280 sets one in the candidate trained model group 290 as the actually used trained model 215 in the imaging unit 210. The actually used trained model 215 may be a trained model that has been set in the imaging unit 210 in or before step S31.

An image captured by the imaging unit 210 is inputted to the information processing apparatus 1 and stored in the image storage unit 230. An image obtaining unit 220 may obtain a captured image inputted from the imaging unit 210 or may obtain a captured image stored in the image storage unit 230.

In step S33, upon input of a tracking AF execution instruction in accordance with a user operation, the imaging unit 210 starts tracking AF for the captured image, and upon input of a tracking AF end instruction in accordance with a user operation, the imaging unit 210 ends (releases) tracking AF.

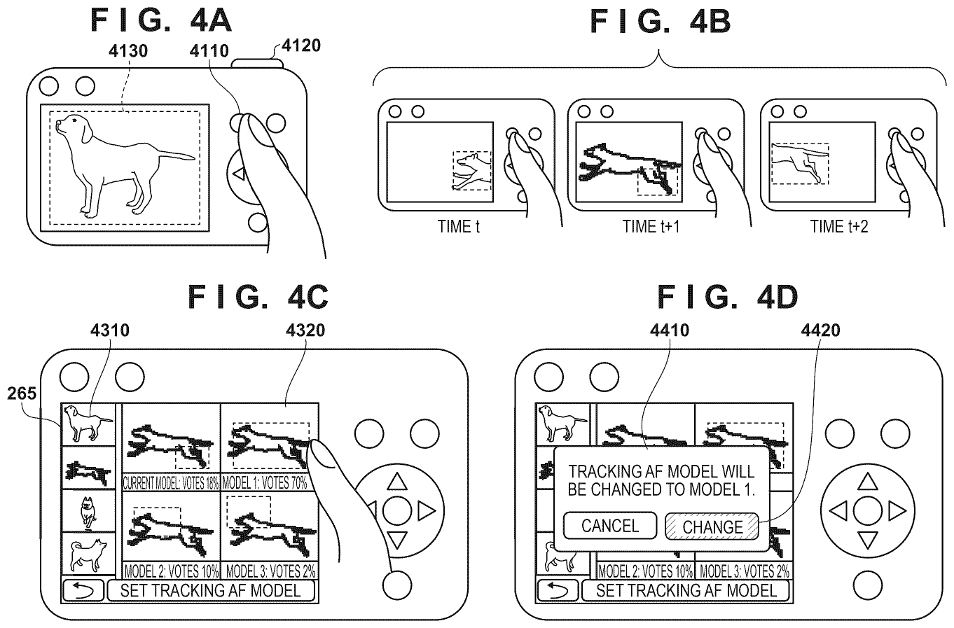

For example, as illustrated in FIG. 4A, the imaging unit 210 displays a captured image on a display screen 4130. The imaging unit 210 executes tracking AF while the user is pressing an AF button 4110 with their finger and ends tracking AF when the user releases their finger from the AF button 4110. For example, the imaging unit 210 performs so-called “thumb AF” in which tracking AF is continued while the AF button 4110 is being pressed with a thumb or performs “shutter half-press AF” in which tracking AF is continued while a shutter button 4120 is being half-pressed. A method of inputting a tracking AF execution instruction/end instruction is not limited to a particular input method.

FIG. 4A illustrates a state in which a dog is imaged as the “subject to be a target of tracking AF”, and a captured image that includes the dog is displayed on the display screen 4130. Further, a bounding box (BB) surrounding the dog is displayed on the display screen 4130 as a result of tracking AF.

In step S34-2, an obtaining unit 240 determines whether an amount of time elapsed from an end timing of last executed tracking AF to a start timing of tracking AF currently being executed is a threshold or less (e.g., 0.5 seconds or less).

As a result of this determination, if the amount of elapsed time is the threshold or less, (i.e., so-called “tracking AF redo”, in which the user inputs a tracking AF end instruction due to failure or the like of tracking AF during tracking AF but inputs a start instruction to immediately re-execute tracking AF, has been performed), the image obtaining unit 220 associates an image of the current frame (frame being captured), which has been obtained from the imaging unit 210 or the image storage unit 230, with “tracking AF release information” as “operation information indicating a user operation on the imaging unit 210”. Then, the processing proceeds to step S34-3. Meanwhile, if the amount of elapsed time is greater than the threshold, that is, if “tracking AF redo” has not been performed, the processing proceeds to step S35.

FIG. 4B illustrates states of the imaging unit 210 performing tracking AF with a running dog as the “subject to be a target of tracking AF”. The left end illustrates a state of the imaging unit 210 at time t, the center illustrates a state of the imaging unit 210 at time (t+1), and the right end illustrates a state of the imaging unit 210 at time (t+2).

At time t, the user is pressing the AF button 4110 with their finger, and as a result of tracking AF, the dog is in focus and a bounding box is displayed at the position of the dog.

At time (t+1), the user is pressing the AF button 4110 with their finger, but as a result of tracking AF, the dog is not in focus and the position and size of the bounding box does not match the position and size of the dog in the image. In this case, it is conceivable that the user determines that tracking AF has failed and, in the imaging operation, releases and immediately re-executes tracking AF to redo tracking AF on the dog. In such a case, the captured image of the frame at time (t+1) is suitable as an “image in which tracking AF has failed” for evaluation of respective trained model in the candidate trained model group 290. Therefore, the image obtaining unit 220 associates the captured image of the frame at time (t+1) with “tracking AF release information”.

At time (t+2), since it is after “tracking AF redo”, as a result of tracking AF, the dog is in focus and a bounding box of an appropriate size is displayed in an appropriate position.

In step S34-3, the obtaining unit 240 determines whether an amount of time that is a threshold or more (e.g., 3.0 seconds or more) has elapsed from a starting timing of tracking AF currently being executed. As a result of this determination, if an amount of time that is the threshold or more has elapsed from a starting timing of tracking AF currently being executed, tracking AF is being accurately executed in a series of imaging operations and a frame after tracking AF has been continued for a long time is suitable as an “image in which tracking AF has succeeded” for evaluation of the candidate trained model group 290, and thus, the image obtaining unit 220 associates an image of the current frame, which has been obtained from the imaging unit 210 or the image storage unit 230, with “tracking AF continuation information” as “operation information indicating a user operation on the imaging unit 210”. Then, the processing proceeds to step S35. Meanwhile, if an amount of time that is the threshold or more has not elapsed from a starting timing of tracking AF currently being executed, the processing proceeds to step S36.

In step S35, the selection unit 260 selects a captured image to be used for evaluation of the candidate trained model group 290, as a selected image (representative image), from captured images obtained by the image obtaining unit 220.

For example, the selection unit 260 may select, as a representative image, a captured image associated with “tracking AF release information” as the operation information among captured images obtained by the image obtaining unit 220. Further, for example, the selection unit 260 may select a captured image associated with “tracking AF continuation information” as the operation information among captured images obtained by the image obtaining unit 220 as the representative image. A representative image group 265 is a set of representative images selected by the selection unit 260. A representative image may be a single still image or may be a moving image that includes a plurality of frames of captured images.

In step S36, the selection unit 260 determines whether the number of representative images included in the representative image group 265 is a prescribed number, which has been set in advance as a number that is not insufficient for evaluation of the candidate trained model group 290, or more.

As a result of this determination, if the number of representative images included in the representative image group 265 is the prescribed number or more, it is determined that the number of representative images is sufficient, and the processing proceeds to step S37. Meanwhile, if the number of representative images included in the representative image group 265 is less than the prescribed number, it is determined that the number of representative images is not sufficient, and the processing proceeds to step S33.

In step S37, a processing execution unit 270 inputs the representative images included in the representative image group 265 into each trained model in the candidate trained model group 290 and performs computation of the trained models to obtain results of subject detection by the trained models as results of subject detection inference.

In step S38, the processing execution unit 270 presents the inference results obtained in step S37 to the user. In step S39, the selection unit 280 determines a trained model to be set as the actually used trained model 215 and changes the trained model currently being used as the actually used trained model 215 to the set trained model.

An example of processing in steps S37 to 39 will be described. For example, as illustrated in FIG. 4C, the processing execution unit 270 displays respective representative images in the representative image group 265 as thumbnails in a list on the display screen of the imaging unit 210. Here, when the user touches a thumbnail 4310 of one representative image in the representative image group 265 with their finger, the processing execution unit 270 inputs the thumbnail 4310 or a captured image corresponding to the thumbnail 4310 into each trained model in the candidate trained model group 290 and performs computation of the trained models and thereby obtains inference results. The processing execution unit 270 displays the inference results of the respective trained models in the candidate trained model group 290 in a grid in a display region 4320. In the display region 4320, an inference result (bounding box of the subject in captured images corresponding to the thumbnail 4310) is displayed for each of the current model (actually used trained model 215), model 1, model 2, and model 3.

Then, the user touches an inference result suitable for their purpose with their finger from the inference results of respective trained models displayed in the display region 4320. The processing execution unit 270 increments a counter corresponding to an inference result each time the inference result is touched and displays a proportion relative to the total of counters as votes. In FIG. 4C, 18%, which is a proportion of the counter of the current model relative to the total of counters of respective models (current model (actually used trained model 215), model 1, model 2, and model 3) is displayed as votes for the current model. Similarly, 70%, 10% and 2% are displayed as votes for respective models (model 1, model 2 and model 3).

Such processing is repeated each time the user selects and touches a thumbnail in the representative image group 265, and votes corresponding to the trained models change. When the user has selected all of the thumbnails in the representative image group 265, the processing execution unit 270 displays, on a display screen of the imaging unit 210, a dialog 4410 for prompting the user to confirm that model 1 with the most votes will be set as the actually used trained model 215, as illustrated in FIG. 4D. When the user touches a button 4420 with their finger, the selection unit 280 sets model 1 as the actually used trained model 215.

The selection unit 280 may set the trained model with the most votes as the actually used trained model 215 without displaying the dialog 4410. Further, a configuration may be taken such that the processing execution unit 270 calculates an evaluation value of each trained model in the candidate trained model group 290 for one or more representative images in the representative image group 265, and the selection unit 280 sets a trained model for which a maximum evaluation value has been calculated as the actually used trained model 215. As the evaluation value, for example, a subject reliability (likelihood) may be used.

As described above, according to the present embodiment, a captured image suitable for evaluation of trained models to be used in tracking AF can be extracted from a natural series of imaging operations, and evaluation of trained models can be easily performed.

In the present embodiment, a case where tracking AF continuation information or tracking AF release information is associated with a captured image has been described, but tracking AF continuation information or tracking AF release information may be associated with meta data of a captured image.

Further, the above various operation methods performed by the user are examples and are not limited to particular operation methods. For example, a button or the like may be pressed in place of or in addition to a touch operation on the screen.

Further, in the present embodiment, a case where the imaging unit 210 and the information processing apparatus 1 are separate devices has been described, but the imaging unit 210 and the information processing apparatus 1 may constitute one information processing apparatus in which they are integrated. In this case, the information processing apparatus operates so as to evaluate trained models to be used for tracking AF based on an image that it captured and change the trained model.

Further, part or all of the processing described as processing performed by the information processing apparatus 1 may be executed by another apparatus (such as a smartphone or a server on a cloud) connected to the information processing apparatus 1 via the communication unit 160 so as to be capable of communication.

Further, in the present embodiment, a trained model is a model that has been trained for tracking AF, but the processing that a trained model is trained for is not limited to particular processing, and a trained model may be trained for other processing.

### Variation of First Embodiment

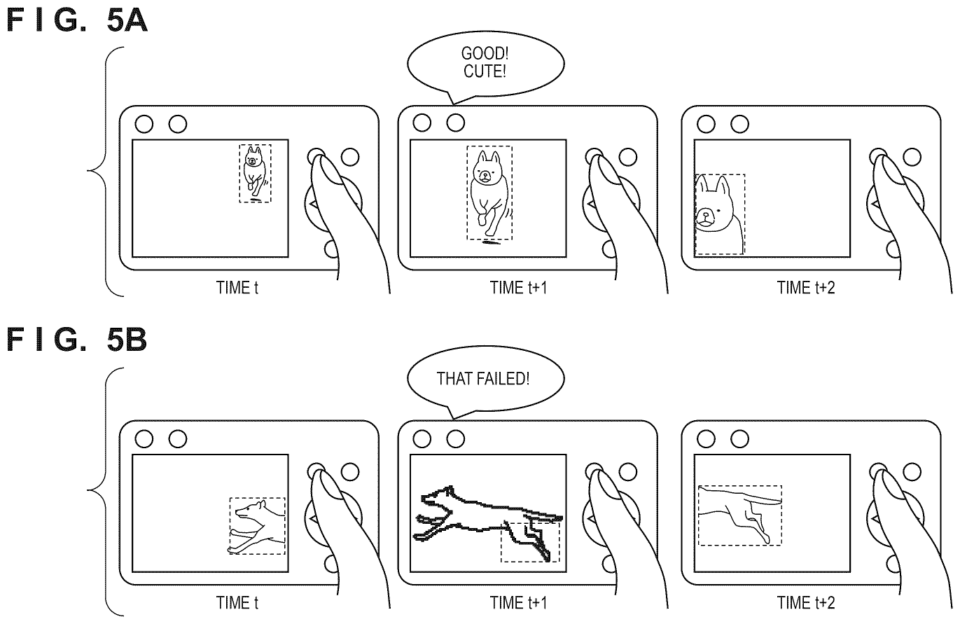

A method of collecting representative images according to the present variation will be described with reference to FIGS. 5A and 5B. FIGS. 5A and 5B illustrate states in which tracking AF is performed with a running dog as the “subject to be a target of tracking AF”. The left end illustrates a state at time t, the center illustrates a state at time (t+1), and the right end illustrates a state at time (t+2).

In FIG. 5A, at any of the times t, (t+1), and (t+2), the user is pressing the AF button 4110 with their finger, and as a result of tracking AF, the dog is in focus and a bounding box is displayed at the position of the dog.

Here, it is assumed that the user determines that a result of inference by a trained model for the image of the frame at time (t+2) is an inference result suitable for the user's purpose. At this time, the user inputs that determination result to the imaging unit 210 by speech. At this time, the selection unit 260 performs speech recognition for the speech uttered by the user, and if a result of speech recognition is a phrase indicating that a “result of inference by a trained model is an inference result suitable for the user's purpose”, such as a phrase explicitly indicating a success (e.g., “success” or “OK”) or a phrase implying a success subconsciously uttered by the user during an imaging operation (e.g., “good” or “cute”), the image at time (t+2) is deemed to be an “image in which tracking AF has succeeded” and the image is selected as a representative image.

In FIG. 5B, at any of the times t, (t+1), and (t+2), the user is pressing the AF button with their finger. As a result of tracking AF, at times t and (t+2), the dog is in focus and a bounding box is displayed at the position of the dog. At time (t+1), the user is also pressing the AF button with their finger, but as a result of tracking AF, the dog is not in focus and the position and size of the bounding box does not match the position and size of the dog in the image.

Here, it is assumed that the user determines that a result of inference by a trained model for the image of the frame at time (t+1) is an inference result not suitable for the user's purpose. At this time, the user inputs that determination result to the imaging unit 210 by speech. At this time, the selection unit 260 performs speech recognition for the speech uttered by the user, and if a result of speech recognition is a phrase indicating that a “result of inference by a trained model is an inference result not suitable for the user's purpose”, such as a phrase explicitly indicating a failure (e.g., “failed” or “NG”) or a phrase implying a failure subconsciously uttered by the user during an imaging operation (e.g., “oh” or “nope”), the image at time (t+1) is deemed to be an “image in which tracking AF has failed” and the image is selected as a representative image.

### Second Embodiment

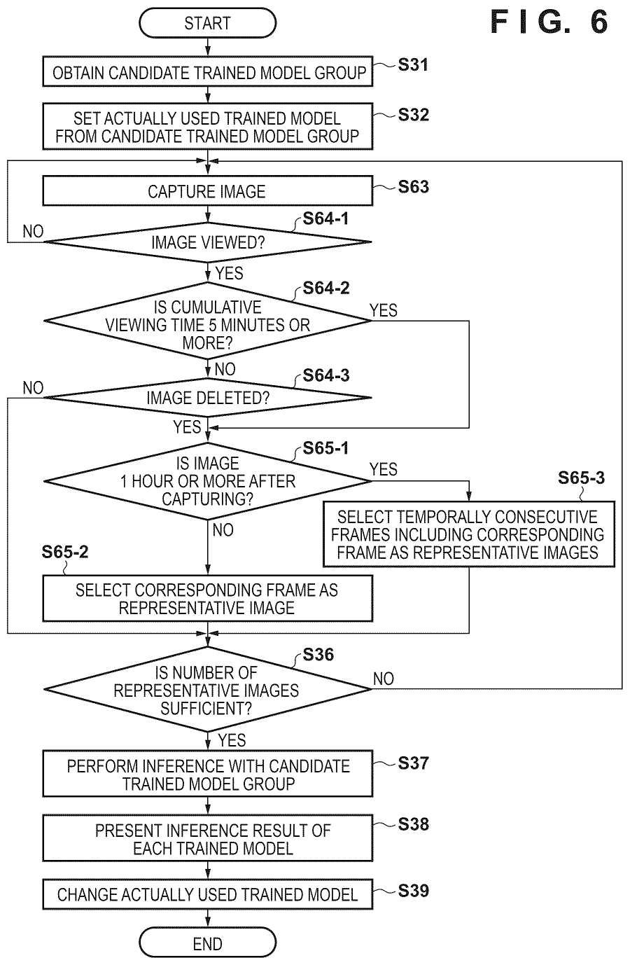

In the present embodiment, differences from the first embodiment will be described, and unless otherwise mentioned below, it is assumed that the rest are similar to the first embodiment. The operation of the system according to the present embodiment will be described in accordance with the flowchart of FIG. 6. In FIG. 6, processing steps similar to the processing steps illustrated in FIG. 3 are given the same step numbers as those processing steps, and description pertaining to those processing step will be omitted.

In step S63, the imaging unit 210 outputs an image (captured image) of a frame captured by the imaging unit 210 according to an imaging instruction inputted by the user operating the imaging unit 210 or the information processing apparatus 1 in association with images (relevant images) of frames included in a prescribed period before and after a timing at which the imaging instruction has been inputted. The “images of frames included in a prescribed period before and after a timing at which the imaging instruction has been inputted” are, for example, images of frames included in a period between 1.5 seconds before and after the timing at which the imaging instruction has been inputted.

In step S64-1, the obtaining unit 240 determines whether images of frames captured by the imaging unit 210 thus far are images that have been displayed on the imaging unit 210 and viewed by the user. As a result of this determination, if the images of the frames captured by the imaging unit 210 thus far are viewed images, the processing proceeds to step S64-2. Meanwhile, if the images of the frames captured by the imaging unit 210 thus far are not viewed images, the processing proceeds to step S63.

In step S64-2, the obtaining unit 240 determines whether a cumulative amount of time for which viewed images have been viewed is a threshold (e.g., 5 minutes) or more. As a result of this determination, if the cumulative amount of time for which viewed images have been viewed is the threshold or more, it is determined that the user is interested in the viewed images, in which case the viewed images are considered to be “favorite images”. Therefore, the image obtaining unit 220 associates the viewed images with “image viewing information” as “operation information indicating a user operation on an image obtained by imaging”. Then, the processing proceeds to step S65-1. Meanwhile, if the cumulative amount of time for which viewed images have been viewed is less than the threshold, the processing proceeds to step S64-3.

In step S64-3, the obtaining unit 240 determines whether an image captured by the imaging unit 210 has been deleted. As a result of this determination, if an image captured by the imaging unit 210 has been deleted, it is determined to indicate that the image is not an image intended by the user, and the image is considered to be an “image for which imaging has failed”. Therefore, the image obtaining unit 220 associates the image with “image deletion information” as “operation information indicating a user operation on an image obtained by imaging”. Then, the processing proceeds to step S65-1. Meanwhile, if the image captured by the imaging unit 210 has not been deleted, the processing proceeds to step S36.

In step S65-1, the obtaining unit 240 sets an image associated with “image viewing information” or “image deletion information” as a target image and determines whether the target image is an image of a frame within a period of a prescribed amount of time (e.g., one hour) from a captured image outputted in association with the target image. This “prescribed amount of time” corresponds, for example, to the above “prescribed period”.

As a result of this determination, if the target image is an image of a frame within a period within the prescribed amount of time from a captured image outputted in association with the target image, the processing proceeds to step S65-3. Meanwhile, if the target image is not an image of a frame within a period within the prescribed amount of time from a captured image outputted in association with the target image, the processing proceeds to step S65-2.

In step S65-2, the selection unit 260 selects the captured image outputted in association with the target image as a representative image. In step S65-3, the selection unit 260 selects the captured image outputted in association with the target image and relevant images outputted in association with the captured image (but deleted relevant images are not included) as representative images.

As described above, according to the present embodiment, images suitable for evaluation of trained models to be used in tracking AF can be extracted from a natural series of operations of the imaging unit 210, and evaluation of trained models can be easily performed.

A method of determining whether an image is a favorite image is not limited to a particular method, and for example, an image with a high RATING may be selected as a favorite image by using a RATING function, which is provided after imaging.

Further, a method of determining whether an image is an image for which imaging has failed is not limited to a particular method, and for example, an image with a low RATING may be selected as an image for which imaging has failed by using a RATING function, which is provided after imaging.

### Variation of Second Embodiment

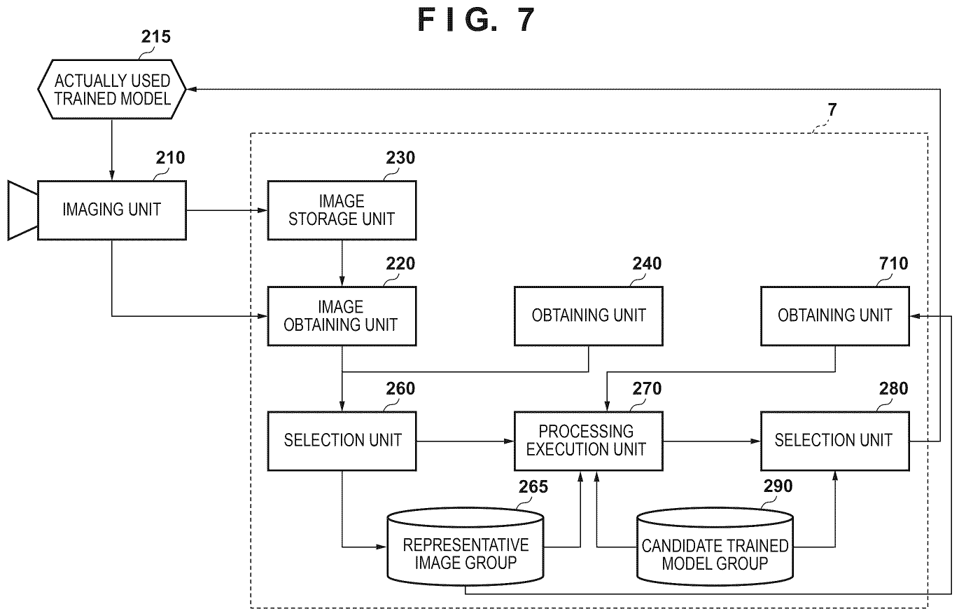

An example of a functional configuration of a system according to the present embodiment is illustrated in a block diagram of FIG. 7. In FIG. 7, functional units similar to the functional units illustrated in FIG. 2 are given the same reference numerals as those functional units, and the description pertaining to those functional units will be omitted.

In step S37, an obtaining unit 710 obtains ground truth information indicating a region of the subject in each representative image in the representative image group 265. A method of obtaining ground truth information in a representative image is not limited to a particular method.

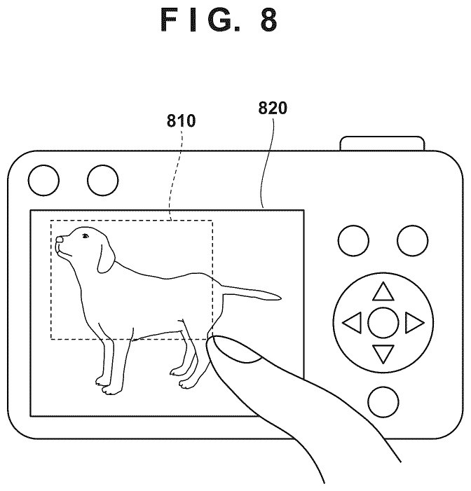

For example, as illustrated in FIG. 8, the obtaining unit 710 displays a representative image on a display screen 820 of the imaging unit 210. The user designates a region (bounding box) 810 of the subject in the representative image displayed on the display screen 820. A method of designating a region is not limited to a particular method. For example, when the display screen of the imaging unit 210 is a touch panel screen, the user may designate a frame surrounding a region of the subject by a touch operation on the touch panel screen. In that case, the obtaining unit 710 obtains information defining the frame (e.g., the coordinates of four corners of the frame, the coordinates of two opposing vertices, the coordinates of one vertex and the height and width of the frame) as ground truth information.

Then, similarly to the first embodiment, the processing execution unit 270 inputs a representative image included in the representative image group 265 to each trained model in the candidate trained model group 290 and performs computation of the trained models to obtain results of subject region detection by the trained model as results of subject detection inference.

In step S38, the selection unit 280 obtains, for each trained model in the candidate trained model group 290, an Intersection over Union (IoU) between a region of the subject detected in each representative image in the representative image group 265 by that trained model and a region indicated by ground truth information of that representative image. Thus, an IoU for each representative image in the representative image group 265 can be obtained for each trained model in the candidate trained model group 290.

Then, the selection unit 280 obtains, for each trained model in the candidate trained model group 290, an average value of IoUs for representative images in the representative image group 265 and extracts, from the candidate trained model group 290, a prescribed number of top trained models in order of descending average value. A method of extracting a plurality of trained models with higher average values is not limited to a particular method.

Then, in step S38, the processing execution unit 270 presents inference results of the trained models extracted from the candidate trained model group 290 in step S37 to the user. The rest is similar to the first embodiment.

When the number of models extracted based on the average value of IoUs obtained in step S38 is equal the number of actually used trained models 215, the selection unit 280 may display the dialog 4410 without acceptance of votes by the user and, upon accepting only an input to the change button 4420, change the actually used trained model 215 or may automatically change the actually used trained model 215 without displaying the dialog 4410.

The numerical values, processing timing, processing order, processing entity, data (information) configuration/obtainment method/transmission destination/transmission source/storage location, and the like used in each of the above embodiments have been given as examples for the sake of providing a concrete explanation, and the present disclosure is not intended to be limited to such examples.

Further, some or all of the embodiments described above may be appropriately combined and used. Further, some or all of the embodiments described above may be selectively used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-084252, filed May 23, 2024, which is hereby incorporated by reference herein in its entirety.

What is claimed is:

1. An information processing apparatus comprising:
a selection unit configured to select a representative image, from among images captured by an imaging unit configured to perform processing in which a trained model is used on a captured image, in accordance with a user operation performed by a user in the capturing; and
a change unit configured to evaluate a plurality of trained models by using the representative image selected by the selection unit and change a trained model to be used by the imaging unit based on a result of the evaluation.

2. The information processing apparatus according to claim 1, wherein
if an amount of time elapsed from an end timing of the processing that has been last performed and a start timing of the processing that is currently being performed is a threshold or less, the selection unit selects an image of a frame that is being captured as a representative image.

3. The information processing apparatus according to claim 1, wherein
in a case where an amount of time elapsed from an end timing of the processing that has been last performed and a start timing of the processing that is currently being performed is a threshold or less and an amount of time that is a threshold or more from the start timing of the processing that is currently being performed has elapsed, the selection unit selects an image of a frame that is being captured as a representative image.

4. The information processing apparatus according to claim 1, wherein
the selection unit selects an image of a frame that is being captured, as a representative image in accordance with input of speech indicating a success or failure of the processing.

5. The information processing apparatus according to claim 1, wherein
the change unit presents, to the user, an inference result of each of the plurality of trained models for a representative image, and changes the trained model to be used by the imaging unit to a trained model selected by the user in accordance with the presentation.

6. The information processing apparatus according to claim 1, wherein
the change unit obtains an evaluation value of each of the plurality of trained model for a representative image and changes the trained model to be used by the imaging unit to a trained model for which a greatest evaluation value has been obtained.

7. The information processing apparatus according to claim 1, wherein
in a case where an image for which a cumulative amount of viewed time is a threshold or more among images of a plurality of frames before and after a captured image is an image of a frame within a period within a prescribed amount of time from the captured image, the selection unit selects the captured image and the images of the plurality of frames as representative images.

8. The information processing apparatus according to claim 1, wherein
in a case where an image for which a cumulative amount of viewed time is a threshold or more among images of a plurality of frames before and after a captured image is not an image of a frame within a period within a prescribed amount of time from the captured image, the selection unit selects the captured image as a representative image.

9. The information processing apparatus according to claim 1, wherein
in a case where an image that has been deleted among images of a plurality of frames before and after a captured image is an image of a frame within a period within a prescribed amount of time from the captured image, the selection unit selects the captured image and the images of the plurality of frames as representative images.

10. The information processing apparatus according to claim 1, wherein
in a case where an image that has been deleted among images of a plurality of frames before and after a captured image is not an image of a frame within a period within a prescribed amount of time from the captured image, the selection unit selects the captured image as a representative image.

11. The information processing apparatus according to claim 1, wherein
the change unit extracts a plurality of trained models from respective trained models based on results of inference of the respective trained models for a representative image and ground truth information of a region of a subject in the representative image, evaluates the plurality of trained models by using the representative image, and changes the trained model to be used by the imaging unit based on a result of the evaluation.

12. The information processing apparatus according to claim 1, wherein
the processing is processing for recognizing a subject in a captured image, adjusting focus on the subject, and tracking the subject.

13. The information processing apparatus according to claim 1, wherein
the information processing apparatus comprises the imaging unit.

14. An information processing method performed by an information processing apparatus, the method comprising:
selecting a representative image, from among images captured by an imaging unit configured to perform processing in which a trained model is used on a captured image, in accordance with a user operation performed by a user in the capturing; and
evaluating a plurality of trained models by using the selected representative image and changing a trained model to be used by the imaging unit based on a result of the evaluation.

15. A non-transitory computer-readable storage medium storing a computer program for causing a computer to function as:
a selection unit configured to select a representative image, from among images captured by an imaging unit configured to perform processing in which a trained model is used on a captured image, in accordance with a user operation performed by a user in the capturing; and
a change unit configured to evaluate a plurality of trained models by using the representative image selected by the selection unit and change a trained model to be used by the imaging unit based on a result of the evaluation.
